(19) United States
(12) Patent Application Publication
(10) Pub. No.: US 2014/0125794 A1
(43) Pub. Date: May 8, 2014

(54) VEHICLE ENVIRONMENT MONITORING DEVICE

(71) Applicant: HONDA MOTOR CO., LTD., Tokyo (JP)

(72) Inventors: TADAHIKO KANOU, Sakura-shi (JP); MASAHIKO ADACHI, Shioya-gun (JP)

(73) Assignee: HONDA MOTOR CO., LTD., Tokyo (JP)

(21) Appl. No.: 14/071,220

(22) Filed: Nov. 4, 2013

(30) Foreign Application Priority Data
Nov. 5, 2012 (JP) 2012-243942

(51) Int. Cl. H04N 7/18

(52) U.S. Cl. CPC H04N 7/183
USPC 348/113

(57) ABSTRACT

A method and system for detecting objects in an environment of a vehicle. The method and system includes calculating an index value indicating a level of received near infrared light based on a difference between gradient values of color pixels and clear pixels in an original image and generating a color image by allocating corrected color gradient values allocated to each clear pixel and color pixel in the original image.

### CROSS REFERENCE TO RELATED APPLICATIONS

The present application claims priority under 35 U.S.C. §119 to Japanese Patent Application No. 2012-243942, filed Nov. 5, 2012, entitled “VEHICLE ENVIRONMENT MONITORING DEVICE”, the contents of which are incorporated herein by reference in their entirety.

### BACKGROUND

Conventionally, devices have been proposed that detect a vehicle ahead from images captured by a vehicle-mounted color camera and calculate the distance and the relative speed between the vehicle and the vehicle ahead, estimate the time until rear end collision with the vehicle ahead from changes in the distance between vehicles and the relative speed, and issue a warning to the driver (see, for example, Japanese Examined Patent Application Publication No. H6-10839).

Generally, in a color camera, in order to suppress the effects of near infrared light to enhance color reproducibility of captured images, a near infrared (NIR) cut filter is installed. Installing a near infrared cut filter in this manner enhances color reproducibility of the captured image, but it also has an adverse effect in that it lowers the sensitivity of the captured image. Further, lowering the sensitivity is inconvenient as it makes detecting target objects having low brightness that exist in the periphery of the vehicle by discriminating by color from the captured image difficult.

The present disclosure addresses the shortcomings and problems with these conventional systems.

### SUMMARY

In an embodiment of the present disclosure an environment monitoring system with at least one camera mounted on a vehicle is provided. The at least one camera capturing images with an imaging element including a plurality of color light receiving pixels receiving light through a color filter and a plurality of clear light receiving pixels that receive light without passing through the color filter in an original image data. An image controller communicates with the at least one camera and receiving the original image data. The image controller including: an original image acquiring portion acquiring the original image data, in which a plurality of color pixels where a gradient value is allocated individually according to the level of light received by each color light receiving pixel and a plurality of clear pixels where a gradient value is allocated individually according to the level of light received by each clear light receiving pixel are arranged, a near infrared light level estimating portion estimating a level of near infrared light received by the imaging element based on a difference between the gradient value of the color pixels and the gradient value of the clear pixels for the original image data; a color image generating portion generates a color image, for each of the pixels of the original image data, by allocating to clear pixels a corrected color gradient value, in which a color gradient value allocated according to a gradient value of a color pixel arranged peripherally is corrected based on the level of near infrared light estimated by the near infrared light level estimating portion, as a gradient value for a pixel in a corresponding placement position in a color image, and allocating to color pixels a corrected color gradient value, in which a color gradient value allocated according to a gradient value arranged peripherally, or the gradient value itself, is corrected based on the level of near infrared light estimated by the near infrared light level estimating portion, as a gradient value for a pixel in a corresponding placement position in a color image; and a target object detecting portion analyzes the color image to detect a target object that exists in a periphery of the vehicle.

In another embodiment of the present disclosure, a vehicle with at least one camera mounted on the vehicle, the camera capturing images with an imaging element including a plurality of color light receiving pixels receiving light through a color filter and a plurality of clear light receiving pixels that receive light without passing through the color filter in an original image data. An image controller communicates with the at least one camera receiving the original image data from the at least one camera. The image controller including: an original image acquiring portion acquiring the original image data from the at least one camera, in which a plurality of color pixels where a gradient value is allocated individually according to the level of light received by each color light receiving pixel and a plurality of clear pixels where a gradient value is allocated individually according to the level of light received by each clear light receiving pixel are arranged; a near infrared light level estimating portion estimating a level of near infrared light received by the imaging element based on a difference between the gradient value of the color pixels and the gradient value of the clear pixels for the original image data; a color image generating portion generates a color image, for each of the pixels of the original image data, by allocating to clear pixels a corrected color gradient value, in which a color gradient value allocated according to a gradient value of a color pixel arranged peripherally is corrected based on the level of near infrared light estimated by the near infrared light level estimating portion, as a gradient value for a pixel in a corresponding placement position in a color image, and allocating to color pixels a corrected color gradient value, in which a color gradient value allocated according to a gradient value arranged peripherally, or the gradient value itself, is corrected based on the level of near infrared light estimated by the near infrared light level estimating portion, as a gradient value for a pixel in a corresponding placement position in a color image; and a target object detecting portion analyzes the color image to detect a target object that exists in a periphery of the vehicle. A vehicle controller including a steering control unit, a braking control unit, and a display control unit. A controller area network enables communications between the vehicle controller, the image controller, the steering control unit, the braking control unit, and the display control unit. The vehicle controller receives target object detection information in the periphery of the vehicle and sends command signals to either one of the steering control unit, the braking control unit, and the display control unit based on the target object detection information and a set of predetermined vehicle and environmental conditions.

In yet another embodiment of the present disclosure is a method of detecting objects including the steps of: acquiring an original image of a periphery of a vehicle with a vehicle mounted camera, calculating an average gradient value of all color and clear pixels of the original image, and calculating a correction index, the correction index indicating an estimated level of a near infrared light received by an imaging element of the camera with a coefficient indicating a sensitivity difference between the white/clear light receiving pixels and the color light receiving pixels in a visible light region.

These and still other aspects will be apparent from the description that follows. In the detailed description, preferred example embodiments will be described with reference to the accompanying drawings. These embodiments do not represent the full scope of the concept; rather the concept may be employed in other embodiments. Reference should therefore be made to the claims herein for interpreting the breadth of the disclosure.

### BRIEF DESCRIPTION OF THE DRAWINGS

FIG. 1 is a configuration drawing of a vehicle environment monitoring device according to an embodiment of the present disclosure.

FIGS. 2A and 2B are descriptive drawings of a filter of an imaging element and of an image captured by a camera according to an embodiment of the present disclosure.

FIG. 3 is an operation flowchart of the vehicle environment monitoring device according to an embodiment of the present disclosure.

FIG. 4 is a descriptive drawing of the characteristics of a color filter according to an embodiment of the present disclosure.

FIGS. 5A and 5B are descriptive drawings of a pre-correction color image and a color image according to an embodiment of the present disclosure.

FIG. 6 is a first flowchart of a calculation process of an average gradient value according to an embodiment of the present disclosure.

FIG. 7 is a second flowchart of a calculation process of an average gradient value according to another embodiment of the present disclosure.

FIG. 8 is a descriptive drawing of a road surface block and a dividing line block according to an embodiment of the present disclosure.

### DETAILED DESCRIPTION

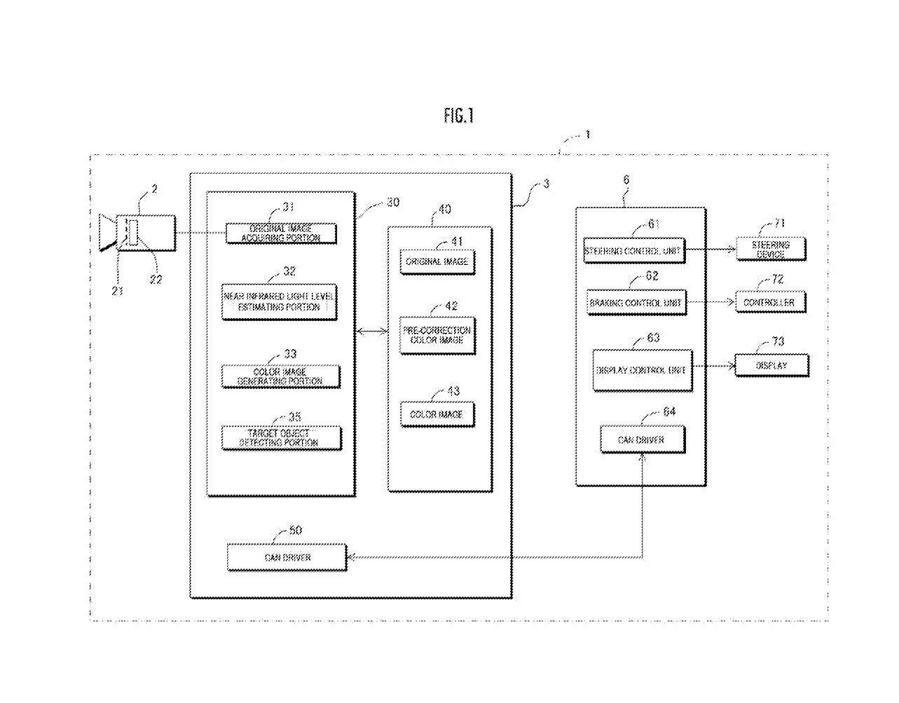

The present disclosure describes a vehicle environment monitoring system and method utilizing a vehicle-mounted camera for detecting and monitoring target objects having low brightness in the periphery of the vehicle by accurately discriminating by color. Embodiments of an image process system and method of the present disclosure are described with reference to FIGS. 1 to 8.

Referring to FIG. 1, a vehicle environment monitoring device includes a camera 2 mounted on a vehicle 1 and an image controller 3 connected to the camera, according to one embodiment of the present disclosure. Please note, that the present disclosure contemplates a plurality of cameras, mounted or attached to vehicle 1, for capturing images around the entire vehicle periphery while keeping within the scope and spirit of the present disclosure.

Camera 2 captures images around a perimeter/periphery of vehicle 1 using an imaging element 22 (CCD, CMOS, or the like) that incorporates a filter 21 and outputs image data to a control circuit 30. Imaging element 22 is configured by two-dimensionally placing a plurality of (m×n number) of light receiving elements.

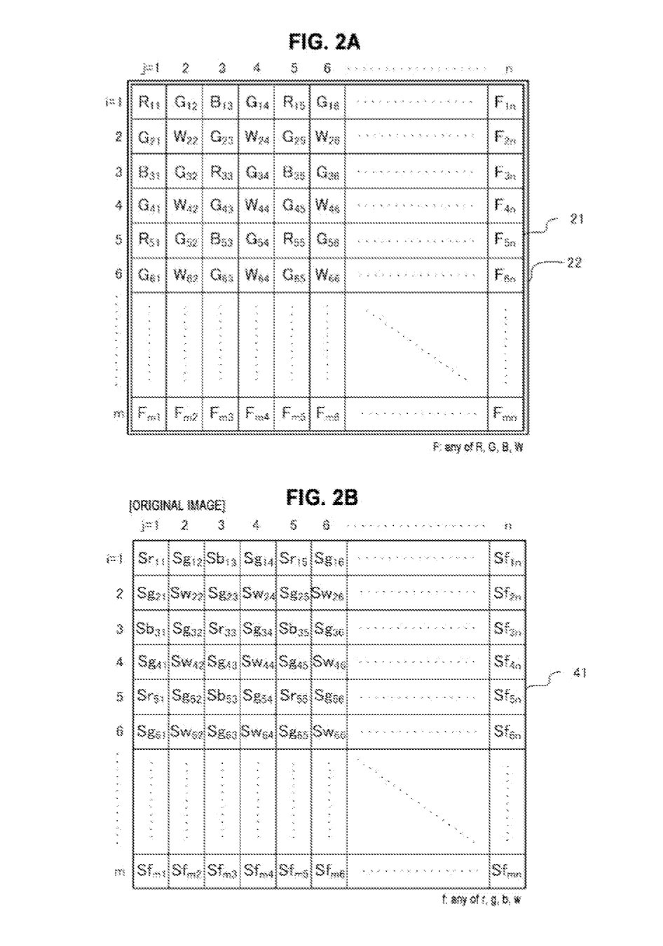

Referring to FIG. 2A, filter 21 is configured so that any one of a color filter of three primary colors of red (R), green, (G), and blue (B) is placed in a light receiving path of each m×n number of light receiving pixels of imaging element 22. Please note that other types of color filters, other than R, G, and B (such as a complementary color filter system of Cyan, Magenta, and Yellow), may be used as the color filter while keeping within the scope and spirit of the present disclosure.

Camera 2 outputs data of a gradient value according to the light receiving level per a predetermined time for a R light receiving pixel having a R filter installed (corresponding to the color light receiving pixel of the present disclosure indicated in the drawing by R₁₁, R₁₅, and the like), a G light receiving pixel having a G filter installed (corresponding to the color light receiving pixel of the present disclosure indicated in the drawing by G₁₂, G₁₄, and the like), a B light receiving pixel having a B filter installed (corresponding to the color light receiving pixel of the present disclosure indicated in the drawing by B₁₃, B₃₁, and the like), and a W light receiving pixel having no filter installed (corresponding to the clear or white light receiving pixel of the present disclosure indicated in the drawing by W₂₂, W₂₄, and the like) as image data to image controller 3.

Image controller 3 includes a control circuit 30 configured with a CPU (not illustrated), memory, input and output circuitry, and the like, image memory 40, and a controller area network (CAN) driver 50.

Control circuit 30 executes, with the CPU, image processing programs or portions stored in memory to thereby function as an original image acquiring portion 31, a near infrared light level estimating portion 32, a color image generating portion 33, and a target object detecting portion 35. Note that all or a part of original image acquiring portion 31, near infrared light level estimating portion 32, color image generating portion 33, and target object detecting portion 35 may be configured of hardware or software of control circuit 30 or CPU.

Original image acquiring portion 31 outputs a control signal to camera 2 to capture an image of the perimeter/periphery of vehicle 1 and acquires data of an original image 41 by imaging data output from camera 2 and stores the data in image memory 40.

Gradient values in original image 41 for the light receiving pixels (R light receiving pixel, G light receiving pixel, B light receiving pixel, and W light receiving pixel) according to imaging element 22 illustrated in FIG. 2A are allocated individually as gradient values of pixels of corresponding placement positions (placement position is the same pixel) as illustrated in FIG. 2B. In FIG. 2B, the gradient values of the pixels are expressed by an upper case S+ any of lower case r, g, b, w+i,j (i=1, 2, . . . , m and j=1, 2, . . . , n).

Where r indicates a gradient value of a pixel in a placement position that corresponds to the R light receiving pixel in FIG. 2A (hereinafter referred to as R pixel and corresponds to the color pixel of the present disclosure); g indicates a gradient value of a pixel in a placement position that corresponds to the G light receiving pixel in FIG. 2A (hereinafter referred to as G pixel and corresponds to the color pixel of the present disclosure); b indicates a gradient value of a pixel in a placement position that corresponds to the B light receiving pixel in FIG. 2A (hereinafter referred to as B pixel and corresponds to the color pixel of the present disclosure); w indicates a gradient value of a pixel in a placement position that corresponds to the W light receiving pixel in FIG. 2A (hereinafter referred to as W pixel and corresponds to the clear pixel of the present disclosure).

Near infrared light level estimating portion 32 estimates a level of near infrared light (light of a wavelength of approximately from 780 nm to 1100 nm that can be received by imaging element 22 of the near infrared light) received by imaging element 22 based on a difference between the gradient value of the W pixel and the gradient values of the R pixel, G pixel, and B pixel of original image 41. Color image generating portion 33 generates a color image 43 by performing corrections according to the received light level of near infrared light on a pre-correction color image 42 generated from original image 41. A generation process of a color image 43 is described below.

Target object detecting portion 35 uses color image 43 to detect lane marks, other vehicles, traffic signals, and the like on the road where vehicle 1 is driving and sends various control signals to a vehicle controller 6 according to the detection results.

Vehicle controller 6 is an electronic circuitry unit configured of a CPU (not illustrated), memory, input and output circuitry, and the like, and executes, by way of the CPU, control programs of vehicle 1 stored in memory to thereby function as a steering control unit 61 that controls the operation of a steering device 71, a braking control unit 62 that controls the operation of a braking device 72, and a display control unit 63 that controls the display of a display 73. Image controller 3 and vehicle controller 6 communicate through CAN drivers 50 and 64 over a controller area network (CAN).

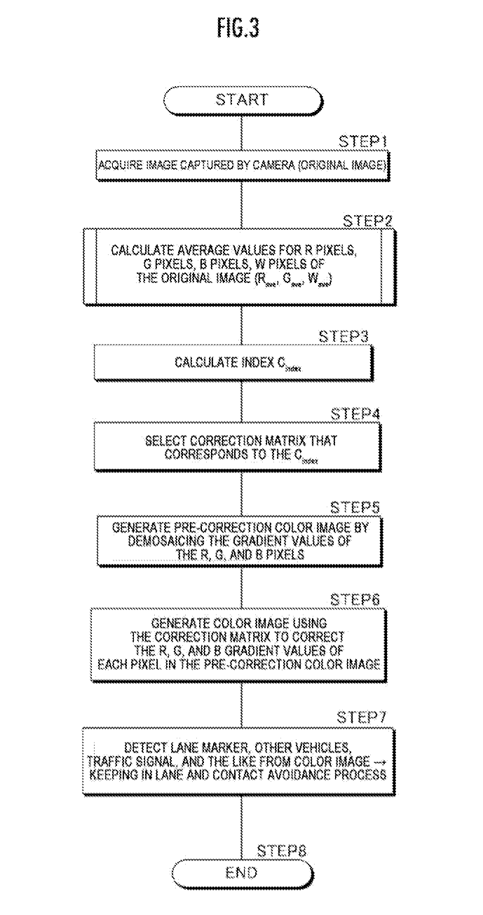

Next, generation of color image 43 by control circuit 30 and processing of the target object detection from color image 43 are described in the flowchart illustrated in FIG. 3. Control circuit 30 executes the flowchart illustrated in FIG. 3 for each predetermined control cycle to detect the target objects.

Step 1 of FIG. 3 is a process by original image acquiring portion 34. Original image acquiring portion 31 acquires original image 41 (see FIG. 2B) by the imaging data output from camera 2 and stores it in image memory 40.

Calculation of the Correction Index C_{index}

Steps 2 and 3 are processes by near infrared light level estimating portion 32. Near infrared light level estimating portion 32 calculates Rₐᵥₑ, which is the average value of the gradient values of the R pixels of original image 41, Gₐᵥₑ, which is the average value of the gradient values of the G pixels, Bₐᵥₑ, which is the average value of the gradient values of the B pixels, and Wₐᵥₑ, which is the average value of the gradient values of the W pixels.

Here, the method for calculating the Rₐᵥₑ, Gₐᵥₑ, Bₐᵥₑ, and Wₐᵥₑ may be to calculate the average value of the gradient values for all of the R pixels, G pixels, B pixels, and W pixels for original image 41, and it may be to calculate the average value of the gradient values for the R pixels, G pixels, B pixels, and W pixels in a region of original image 41 where there is a high likelihood that the region is an image portion of a road, a white or yellow line (lane dividing line).

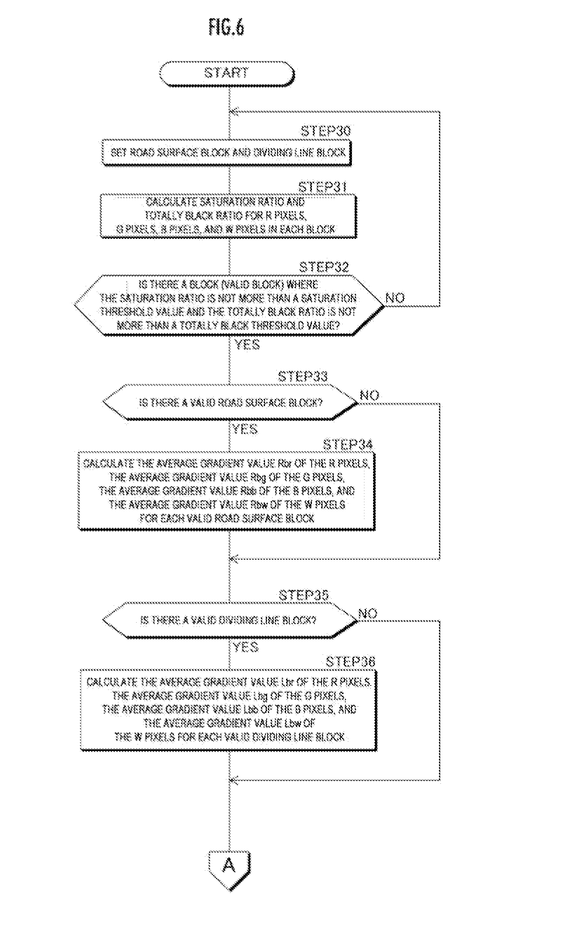

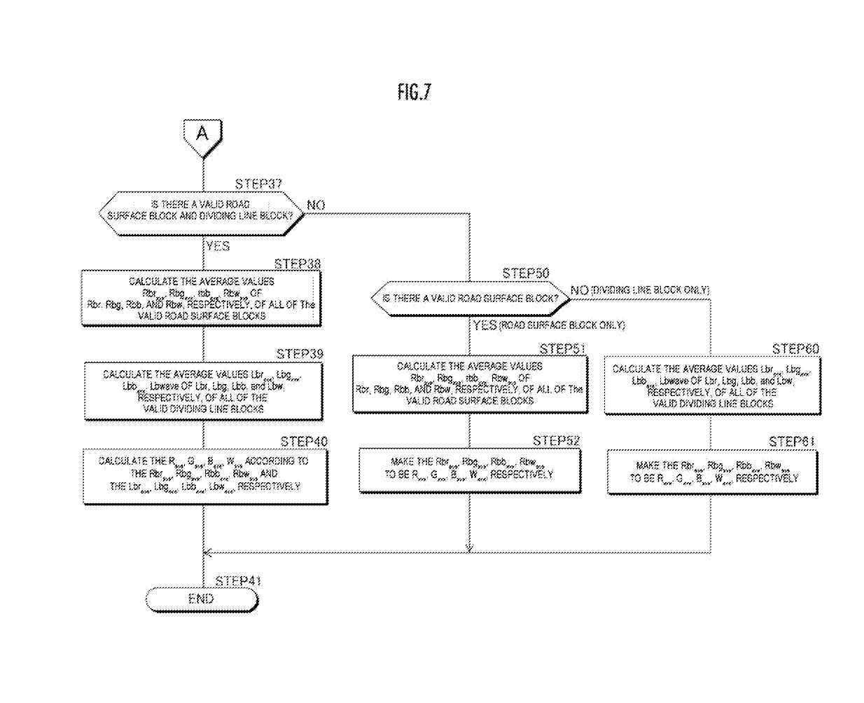

Preferably, the average value of the gradient values is calculated for the R pixels, G pixels, B pixels, and W pixels in a region of an image portion of the road or in a region of an image portion having white or yellow lines (both solid and dashed lines) detected from color image 43 by target object detecting portion 35 in the preceding control cycle. The process in this case is described below with reference to the flowcharts illustrated in FIGS. 6 and 7.

Next, near infrared light level estimating portion 32 calculates, by Formula (1) below, a C_{index} is an index that indicates an estimated level of the near infrared light received by imaging element 22.

$$\begin{matrix}Formula 1 & \\ {C}_{index} = \frac{k \times ( {R}_{ave} + {G}_{ave} + {B}_{ave} ) - {W}_{ave}}{k} & ( 1 )\end{matrix}$$

Where in Formula (1), k is a coefficient calculated by Formula (2) below for the sRₐᵥₑ, sGₐᵥₑ, sBₐᵥₑ, and sWₐᵥₑ which are the average values of the gradient values of R pixels, G pixels, B pixels, and W pixels calculated for a predetermined region of the captured image of camera 2 when the light from which near infrared light is removed using the near infrared cut filter on a D65 light source or a pseudo sunlight source in advance is irradiated on an achromatic test target.

$$\begin{matrix}Formula ( 2 ) & \\ k = \frac{{sW}_{ave}}{{SR}_{ave} + {sG}_{ave} + {sB}_{ave}} & ( 2 )\end{matrix}$$

Where in Formula (2), k is a coefficient indicating a sensitivity difference between the W light receiving pixels and the R, G, and B light receiving pixels in a visible light region.

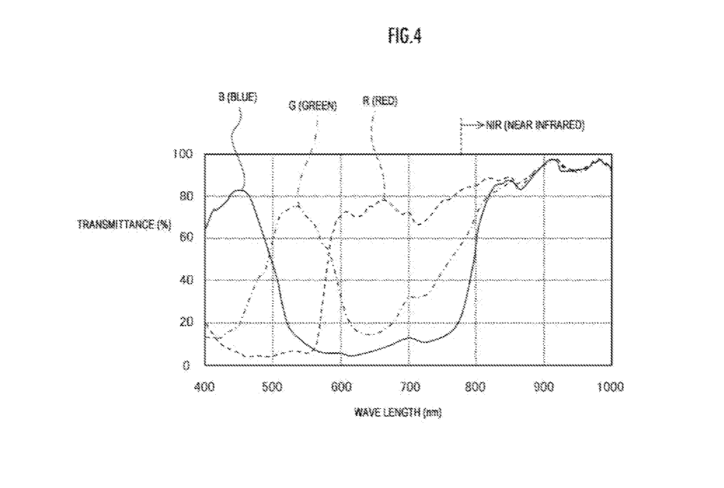

Referring to FIG. 4, the gradient value of the R pixels is the gradient value according to the light receiving level of light in the R region and in the near infrared region, the gradient value of the G pixels is the gradient value according to the light receiving level of light in the G region and in the near infrared region, and the gradient value of the B pixels is the gradient value according to the light receiving level of light in the B region and in the near infrared region. Furthermore, the gradient value of the W pixels is the gradient value according to the light receiving level of light in the entire region including the R, G, and B regions and near infrared region.

Therefore, C_{index} calculated by Formula (1) is an extracted gradient value for only the light receiving level portion of near infrared light and can be used as an index to indicate the light receiving level (estimated level) of near infrared light.

Steps 4 to 6 are processes by color image generating portion 33.

Selection of the Correction Matrix Corresponding to the C_{index}

Color image generating portion 33 determines a correction matrix (each matrix element corresponding to the correction factor of the present disclosure) for white balance adjustment according to the C_{index} that is an index value of the light receiving level of near infrared light. The correction matrix is set according to pre-test results.

The pre-test is performed by irradiating a light source having various color temperatures onto a test target and imaging by camera 2. Specifically, average values Rₐᵥₑ, Gₐᵥₑ, Bₐᵥₑ, and Wₐᵥₑ of the gradient values of R pixels, G pixels, B pixels and W pixels are calculated for original image 41 irradiated by each light source, and the C_{index} is calculated by Formula (1).

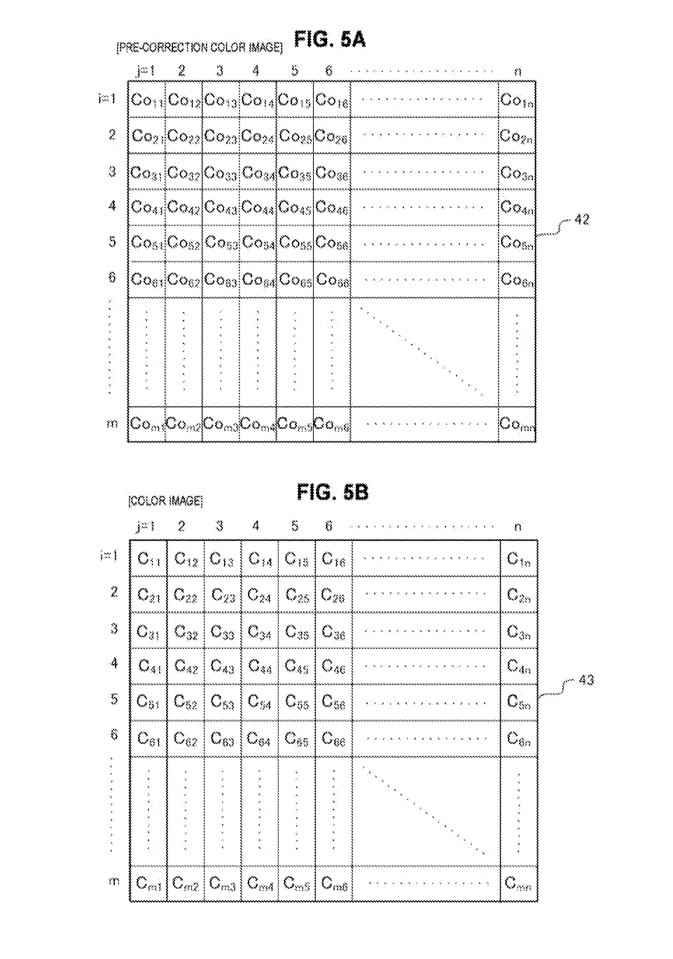

Referring to FIG. 5A, using a least square method, a correction matrix is found for converting from the R, G, and B gradient values Co_{i,j}r, Co_{i,j}g, Co_{i,j}b, (calculation of each gradient value will be described below) for each pixel of pre-correction color image 42 generated from the gradient values of the R pixels, G pixels, and B pixels of original image 41 to R, G, and B gradient values C_{i,j}r, C_{i,j}g, C_{i,j}b for each pixel of color image 43 to create a picture optimal for recognition of the target images of, including but not limited to: a lane dividing line, crosswalk lines, vehicles, pedestrian, traffic signals, bicyclists, motorcycles, trees, buildings, and the like (any objects or markings encountered in driving situations on roads). With this method, the C_{index} and the correction matrix correspond one-to-one, but as long as the required reproducibility is met, a single correction matrix may be used for a C_{index} of a certain range.

The correction matrix may be a simple 3×3 matrix, as shown in Formula (3) below. Additionally, the present disclosure also contemplates using a 3×6 matrix or a 3×9 matrix for improved reproducibility.

$$\begin{matrix}Formula ( 3 ) & \\ ( \begin{matrix}{C}_{i , j} r \\ {C}_{i , j} g \\ {C}_{i , j} b\end{matrix} ) = A ( \begin{matrix}{Co}_{i , j} r \\ {Co}_{i , j} g \\ {Co}_{i , j} b\end{matrix} ) = ( \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ) ( \begin{matrix}{Co}_{i , j} r \\ {Co}_{i , j} g \\ {Co}_{i , j} b\end{matrix} ) & ( 3 )\end{matrix}$$

Where C_{i,j}r, C_{i,j}g, C_{i,j}b are R, G, and B gradient values of pixels after correction, respectively; A is a correction matrix; a₁₁, a₂₁, . . . , a₃₃ are coefficients of correction matrix A; and Co_{i,j}r, Co_{i,j}g, Co_{i,j}b are R, G, and B gradient values of pixels before correction, respectively.

In this embodiment, correction matrixes are prepared in a number sufficient for securing favorable color reproducibility according to the C_{index} that indicates the light receiving level of near infrared light. Further, color image generating portion 33 selects the appropriate correction matrix; for example, when the value of the C_{index} is α<C_{index}≦β, the correction matrix A1 is selected and when the value of the C_{index} is β<C_{index}≦γ, the correction matrix A2 is selected.

Generation of the Pre-Correction Color Image

In step 5 of FIG. 3, color image generating portion 33 performs demosaicing on the gradient values of each pixel of original image 41 and generates pre-correction color image 42 illustrated in FIG. 5A. In pre-correction color image 42 of FIG. 5A, the gradient values of each pixel are indicated by Co_{i,j} (i=1, 2, . . . , m, j=1, 2, . . . , n).

Co_{i,j}, as described below, have elements of the three gradient values of the R value (gradient values of Co_{i,j}r, R), the G value (gradient values of Co_{i,j}g, G), and the B value (gradient values of Co_{i,j}b, B). Co_{i,j}={Co_{i,j}r, Co_{i,j}g, Co_{i,j}b}

Allocation of the G Value to Co_{i,j}

Color image generating portion 33 calculates the G value (Co_{i,j}g) allocated to each pixel (Co_{i,j}) of pre-correction color image 42. For the G pixels (pixels where the gradient value is Sg_{i,j}) of original image 41, the gradient value itself is made to be the G value of pixels in the corresponding placement position (pixels in the same placement position) in pre-correction color image 42. For example, with color image generating portion 33, the gradient value (Sg_{2, 3}) of a pixel where (i,j)=(2, 3) in original image 41 is made to be G value (Co_{2, 3}g) of the pixel where (i,j)=(2, 3) in pre-correction color image 42.

Further, in regard to the R pixels (pixels where the gradient value is Sr_{i,j}), the B pixels (pixels where the gradient value is Sb_{i,j}), and the W pixels (pixels where the gradient value is Sw_{i,j}) of original image 41, the pixels that are vertically and laterally adjacent become G pixels as illustrated in FIG. 2B. Therefore, color image generating portion 33 calculates a G value (Co_{i,j}g) allocated to pixels in the corresponding placement position in pre-correction color image 42 using Formulas (4), (5), (6), and (7) for the gradient values of the G pixels that are vertically and laterally adjacent to the target R B W pixels (Sg_{i-1, j}, Sg_{i+1, J}, Sg_{i,j-1}, Sg_{i,j+1}).

$$\begin{matrix}Formula ( 4 ) & \\ I 1 = \vert {Sg}_{i + 1 , j} - {Sg}_{i - 1 , j} \vert & ( 4 ) \\ Formula ( 5 ) & \\ J 1 = \vert {Sg}_{i , j + 1} - {Sg}_{i , j - 1} \vert & ( 5 ) \\ Formula ( 6 ) & \\ {Co}_{i , j} g = \frac{{Sg}_{i + 1 , j} + {Sg}_{i - 1 , j}}{2} ( when I 1 < J 2 ) & ( 6 ) \\ Formula ( 7 ) & \\ {Co}_{i , j} g = \frac{{Sg}_{i , j + 1} + {Sg}_{i , j - 1}}{2} ( when I 1 > J 1 ) & ( 7 )\end{matrix}$$

Allocation of the R Value to Co_{i,j}

Next, color image generating portion 33 calculates R value (Co_{i,j}r) allocated to each pixel (Co_{i,j}) of pre-correction color image 42. For the R pixels (pixels for the gradient value is Sr_{i,j}) of original image 41, the R value (Sr_{i,j}) itself is made to be the R value (Co_{i,j}r) of the pixels in the corresponding position in pre-correction color image 42. For example, with color image generating portion 33, gradient value (Sr_{3, 3}) of a pixel where (i,j)=(3, 3) in original image 41 is made to be the R value (Co_{3, 3}r) of the pixel where (i,j)=(3, 3) in pre-correction color image 42.

Further, in regard to the B pixels (pixels for the gradient value is Sb_{i,j}) in original image 41, the vertical and lateral second pixels become R pixels as illustrated in FIG. 2B. Therefore, color image generating portion 33 calculates the R value (Co_{i,j}r) allocated to pixels in the corresponding placement position in pre-correction color image 42 using Formulas (8), (9), (10), and (11) for the target B pixels.

$$\begin{matrix}Formula ( 8 ) & \\ I 2 = \vert {Sr}_{i + 2 , j} - {Sr}_{i - 2 , j} \vert & ( 8 ) \\ Formula ( 9 ) & \\ J 2 = \vert {Sr}_{i , j + 2} - {Sr}_{i , j - 2} \vert & ( 9 ) \\ Formula ( 10 ) & \\ {Co}_{i , j} r = \frac{{Sr}_{i + 2 , j} + {Sr}_{i - 2 , j}}{2} ( when I 2 < J 2 ) & ( 10 ) \\ Formula ( 11 ) & \\ {Co}_{i , j} r = \frac{{Sr}_{i , j + 2} + {Sr}_{i , j - 2}}{2} ( when I 2 > J 2 ) & ( 11 )\end{matrix}$$

Further, for the W pixels (pixels where the gradient value is Sw_{i,j}) in original image 41, R pixels are placed to the top right and bottom left or to the top left and bottom right as illustrated in FIG. 2B. Therefore, color image generating portion 33 calculates the R value (Co_{i,j}r) allocated to pixels in the corresponding placement position in pre-correction color image 42 using Formulas (12) and (13) for target W pixels in original image 41.

$$\begin{matrix} Formula ( 12 ) & \\ {Co}_{i , j} r = \frac{{Sr}_{i - 1 , j + 1} + {Sr}_{i + 1 , j - 1}}{2} ( when R pixels are placed to the top right and bottom left ) & ( 12 ) \\ Formula ( 13 ) & \\ {Co}_{i , j} r = \frac{{Sr}_{i - 1 , j - 1} + {Sr}_{i + 1 , j + 1}}{2} ( when R pixels are placed to the top left and bottom right ) & ( 13 )\end{matrix}$$

Further, for the G pixels in original image 41, R pixels are placed either vertically or laterally as illustrated in FIG. 2B. Therefore, color image generating portion 33 calculates the R value (Co_{i,j}r) allocated to pixels in the corresponding placement position in pre-correction color image 42 using Formulas (14), (15), (16), and (17) for the target G pixels in original image 41.

Formula (14):

Co_{i,j}r=Sr_{i+1,j}(when R pixels are placed to the bottom side) (14)

Formula (15):

Co_{i,j}r=Sr_{i-1,j}(when R pixels are placed to the top side) (15)

Formula (16):

Co_{i,j}r=Sr_{i,j+1}(when R pixels are placed to the right side) (16)

Formula (17):

Co_{i,j}r=Sr_{i,j-1}(when R pixels are placed to the left side) (17)

Allocation of the B Value to Co_{i,j}

Next, color image generating portion 33 calculates the B value (Co_{i,j}b) allocated to each pixel of pre-correction color image 42. For the B pixels (pixels where the gradient value is Sb_{i,j}) of original image 41, the gradient value itself is made to be the B value of pixels in the corresponding position in the pre-correction color image 42. For example, with color image generating portion 33, the gradient value (Sb_{3, 5}) of a pixel where (i,j)=(3, 5) in original image 41 is made to be the B value (Co_{3, 5}b) of the pixel where (i,j)=(3, 5) in pre-correction color image 42.

Further, in regard to the R pixels of original image 41, the vertical and lateral second pixels become B pixels as illustrated in FIG. 2B. Therefore, color image generating portion 33 calculates the B value (Co_{i,j}b) allocated to pixels in the corresponding placement position in pre-correction color image 42 using Formulas (18), (19), (20), and (21) for the target R pixels.

$$\begin{matrix}Formula ( 18 ) & \\ I 3 = \vert {Sb}_{i + 2 , j} - {Sb}_{i - 2 , j} \vert & ( 18 ) \\ Formula ( 19 ) & \\ J 3 = \vert {Sb}_{i , j + 2} - {Sb}_{i , j - 2} \vert & ( 19 ) \\ Formula ( 20 ) & \\ {Co}_{i , j} b = \frac{{Sb}_{i - 2 , j} + {Sb}_{i - 2 , j}}{2} ( when I 3 < J 3 ) & ( 20 ) \\ Formula ( 21 ) & \\ {Co}_{i , j} b = \frac{{Sb}_{i , j + 2} + {Sb}_{i , j - 2}}{2} ( when I 3 > J 3 ) & ( 21 )\end{matrix}$$

Further, for the W pixels (pixels where the gradient value is Sw_{i,j}), B pixels are placed to the top right and bottom left or to the top left and bottom right as illustrated in FIG. 2B. Therefore, color image generating portion 33 calculates the B value (Co_{i,j}b) allocated to pixels in the corresponding placement position in pre-correction color image 42 using Formulas (22) and (23) for the target W pixels.

$$\begin{matrix} Formula ( 22 ) & \\ {Co}_{i , j} b = \frac{{Sb}_{i - 1 , j + 1} + {Sb}_{i + 1 , j - 1}}{2} ( when B pixels are placed to the top right and bottom left ) & ( 22 ) \\ Formula ( 23 ) & \\ {Co}_{i , j} b = \frac{{Sb}_{i - 1 , j - 1} + {Sb}_{i + 1 , j + 1}}{2} ( when B pixels are placed to the top left and bottom right ) & ( 23 )\end{matrix}$$

Further, in regard to the G pixels (pixels where the gradient value is Sg_{i,j}), the single pixel that is either vertically or laterally adjacent becomes the B pixel as illustrated in FIG. 2B. Therefore, color image generating portion 33 calculates the B value (Co_{i,j}b) allocated to pixels in the corresponding placement position in pre-correction color image 42 using Formulas (24), (25), (26), and (27) for the target G pixels.

Formula (24):

Co_{i,j}b=Sb_{i+1,j}(when B pixels are placed to the bottom side) (24)

Formula (25):

Co_{i,j}b=Sb_{i-1,j}(when B pixels are placed to the top side) (25)

Formula (26):

Co_{i,j}b=Sb_{i,j+1}(when B pixels are placed to the right side) (26)

Formula (27):

Co_{i,j}b=Sb_{i,j-1}(when B pixels are placed to the left side) (27)

By the above process, color image generating portion 33 calculates the R value (Co_{i,j}r), the G value (Co_{i,j}g), and the B value (Co_{i,j}b) allocated to each pixel in pre-correction color image 42 and generates pre-correction color image 42.

Generation of the Color Image

In step 6 of FIG. 3, color image generating portion 33 generates color image 43 having an array illustrated in FIG. 5B from pre-correction color image 42.

In color image 43 of FIG. 5B, the gradient values of each pixel are indicated by C_{i,j} (i=1, 2, . . . , m, j=1, 2, . . . , n). C_{i,j}, as described below, have elements of the three gradient values of the R value (gradient values of C_{i,j}r, R), the G value (gradient values of C_{i,j}g, G), and the B value (gradient values of C_{i,j}b, B). C_{i,j}={C_{i,j}r, C_{i,j}g, C_{i,j}b} Color image generating portion 33 generates color image 43 by conducting correction processing according to Formula (28) for the R, G, and B gradient values of each pixel in the pre-correction color image.

$$\begin{matrix} Formula ( 28 ) & \\ ( \begin{matrix}{C}_{i , j} r \\ {C}_{i , j} g \\ {C}_{i , j} b\end{matrix} ) = ( \begin{matrix}{a}_{11} & {a}_{12} & {a}_{13} & … \\ {a}_{21} & {a}_{22} & {a}_{23} & … \\ {a}_{31} & {a}_{32} & {a}_{33} & …\end{matrix} ) {( \begin{matrix}{Co}_{i , j} r & {Co}_{i , j} g & {Co}_{i , j} b & {Co}_{i , j} {r}^{N} & {Co}_{i , j} {g}^{N} & {Co}_{i , j} {b}^{N} & …\end{matrix} )}^{T} & ( 28 )\end{matrix}$$

However, C_{i,j}r, C_{i,j}g, and C_{i,j}b are R, G, and B gradient values of pixels in color image 43, respectively (corresponding to the corrected color gradient value of the present disclosure); a₁₁, a₁₂, and a₁₃, . . . are coefficients of the correction matrix; Co_{i,j}r, Co_{i,j}g, and Co_{i,j}b are R, G, and B gradient values of pixels in the pre-correction color image 42, respectively; and N is an exponent.

N is a nonlinear exponent (for example, N=0.3, 0.9, and the like) in Formula (28). In addition to the simple exponent values of Co_{i,j}r, Co_{i,j}g, and Co_{i,j}b, other items that may be used to multiply by the correction matrix include a cross item (Co_{i,j}r×Co_{i,j}g, Co_{i,j}g×Co_{i,j}b, Co_{i,j}b×Co_{i,j}r, and the like) or a predetermined function value or the like of a simple item or cross item of these. Note that the item multiplied by the correction matrix corresponds to an element based on at least one of the color gradient values of the three primary colors of the present disclosure.

Target Objection Detection

Step 7 is a process performed by target object detecting portion 35. Target object detecting portion 35 detects target objects that exist in the periphery of vehicle 1, from color image 43 generated in Step 6, including lane markers, other vehicles, traffic signals, and the like. At that time, target object detecting portion 35 determines attributes of a lane marker from the color (white line, yellow line, horizontal line, and the like) of the lane marker. Further, target object detecting portion 35 determines a time to collision (TTC) with a vehicle ahead.

Moreover, target object detecting portion 35 maintains vehicle 1 within the traffic lane from the detected position of the lane markers and sends a control signal to vehicle controller 6 for keeping control in the driving lane, and steering control unit 61 controls the operation of steering device 71 according to the received control signal.

Further, target object detecting portion 35, when another vehicle with which there is a contact possibility is detected, sends a signal to vehicle controller 6 to mandate execution of contact avoidance measures. In addition, target object detecting portion 35, when a red light of a traffic signal in front is detected, and when a braking operation does not occur by the driver, sends a warning signal to vehicle controller 6, and display control unit 63 displays the warning on a display in accordance with receiving the warning signal. Further, as necessary, braking control unit 62 operates braking device 72 to brake vehicle 1. The present disclosure also contemplates the detection of traffic signs, such as Stop, Pedestrian Crossing, School Zones, and the like to send signals to vehicle controller 6.

Calculation Process of Index C_{index}

Referring to FIGS. 6 and 7, a calculation process for the index Cindex by near infrared light level estimating portion 32 will be described in detail.

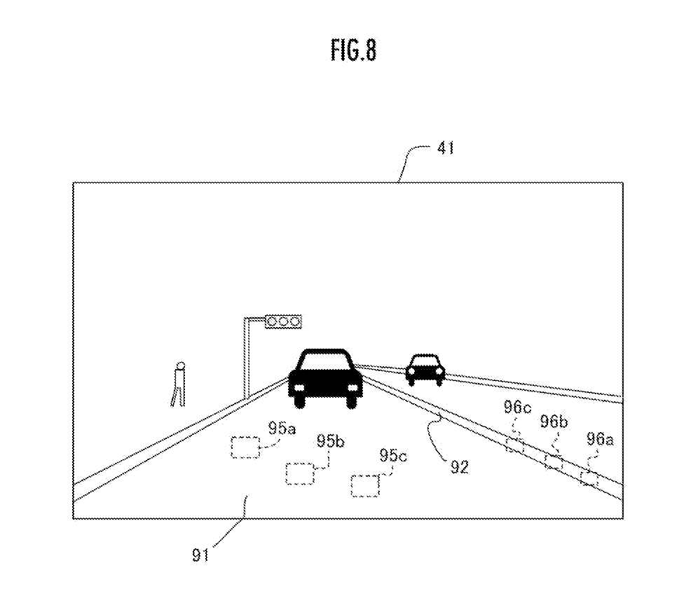

Referring to FIG. 6 at Step 30, near infrared light level estimating portion 32 sets a road surface block and a dividing line block (corresponding to the near infrared light level estimating region of the present disclosure) relative to original image 41. Near infrared light level estimating portion 32, as illustrated in FIG. 8, sets a plurality of road surface blocks 95 (95a, 95b, and 95c) in regions estimated to be an image portion 91 of a road surface in original image 41. Further, near infrared light level estimating portion 32 sets a plurality of dividing line blocks 96 (96a, 96b, and 96c) in regions estimated, or with a high likelihood, to be an image portion 92 of a white or yellow line that divides a lane in original image 41.

Note that estimation of the image portion of the road surface and the image portion of the white line is preferably performed based on the position of the image portion of the road surface and the image portion of the white line detected by color image 43 generated in a preceding control cycle.

In step 31, near infrared light level estimating portion 32 calculates a saturation ratio and a totally black ratio of the R pixels, G pixels, B pixels, and W pixels for each of road surface block 95 and dividing line block 96.

Here, the saturation ratio of the R pixels is a ratio of the number of R pixels in which the gradient value is at the maximum value (255 if the resolution is 8 bit) to the total number of R pixels in each of road surface block 95 and dividing line block 96. This is similar also for the saturation ratios of the G pixels, B pixels, and W pixels. Note that a ruling value for saturation of the W pixels corresponds to the first predetermined value of the present disclosure, and the ruling value for saturation of the R, G, and B pixels corresponds to the second predetermined value of the present disclosure.

Here, the totally black ratio of the R pixels is a ratio of the number of R pixels in which the gradient value is at the minimum value (0) to the total number of R pixels in each of the road surface block 95 and the dividing line block 96. This is similar also for the totally black ratios of the G pixels, B pixels, and W pixels. Note that a ruling value for totally black of the W pixels corresponds to the third predetermined value of the present disclosure, and the ruling value for totally black of the R, G, and B pixels corresponds to the fourth predetermined value of the present disclosure.

Note that the saturation ratio and the totally black ratio of the R pixels, G pixels, B pixels, and W pixels may be calculated by gradient values set near to the maximum value and the minimum value, not by the maximum value and the minimum value.

In step 32, near infrared light level estimating portion 32 determines whether there is a block (valid block) in which the saturation ratio of the W pixels is not more than a first threshold value and none of the saturation ratios of the R, G, and B pixels are more than a second threshold value, and in which the totally black ratio of the W pixels is not more than a third threshold value and none of the totally black ratios of the R, G, and B pixels are more than a fourth threshold value. Moreover, if there is a valid block, it proceeds to step 33, and if there is no valid block, it branches to step 30.

Note that, according to the imaging condition of original image 41, a valid block may be extracted by determining only either one of the saturation ratio or the totally black ratio.

In step 33, near infrared light level estimating portion 32 determines whether there is a valid road surface block 95. Further, if there is a valid road surface block 95, it proceeds to step 34, and if there is no valid road surface block 95, it branches to step 35.

In step 34, near infrared light level estimating portion 32 calculates the average gradient value Rbr of the R pixels, the average gradient value Rbg of the G pixels, the average gradient value Rbb of the B pixels, and the average gradient value Rbw of the W pixels for each of the valid road surface blocks 95.

In step 35, near infrared light level estimating portion 32 determines whether there is a valid dividing line block 96. Further, if there is a valid dividing line block 96, it proceeds to step 36, and if there is no valid dividing line block 96, then it branches to step 37 of FIG. 7.

In step 36, the near infrared light level estimating portion 32 calculates the average gradient value Lbr of the R pixels, the average gradient value Lbg of the G pixels, the average gradient value Lbb of the B pixels, and the average gradient value Lbw of the W pixels for each of the valid dividing line blocks 96.

In step 37 of FIG. 7, near infrared light level estimating portion 32 determines whether there is a valid road surface block 95 and dividing line block 96, and if there is a valid road surface block 95 and dividing line block 96, it proceeds to step 38. Steps 38 to 40 are the calculation process of the average gradient values Rave, Gave, Bave, and Wave for when there is a valid road surface block 95 and dividing line block 96.

In step 38, near infrared light level estimating portion 32 calculates Rbrave, Rbgave, Rbbave, and Rbwave, which are the average values of Rbr, Rbg, Rbb, and Rbw, respectively, of all of the valid road surface blocks 95, using Formulas (29), (30), (31), and (32) for each of the valid road surface blocks 95, where p is a number of valid road surface blocks.

$$\begin{matrix}Formula ( 29 ) & \\ {Rbr}_{ave} = \frac{Rbr 1 + Rbr 2 + … + Rbrp}{p} & ( 29 ) \\ Formula ( 30 ) & \\ {Rbg}_{ave} = \frac{Rbg 1 + Rbg 2 + … + Rbgp}{p} & ( 30 ) \\ Formula ( 31 ) & \\ {Rbb}_{ave} = \frac{Rbb 1 + Rbb 2 + … + Rbbp}{p} & ( 31 ) \\ Formula ( 32 ) & \\ {Rbw}_{ave} = \frac{Rbw 1 + Rbw 2 + … + Rbwp}{p} & ( 32 )\end{matrix}$$

In step 39, near infrared light level estimating portion 32 calculates Lbrₐᵥₑ, Lbgₐᵥₑ, Lbbₐᵥₑ, and Lbwₐᵥₑ, which are average values of Lbr, Lbg, Lbb, and Lbw, respectively, of all of the valid dividing line blocks 96, using Formulas (33), (34), (35), and (36), where q is a number of valid dividing line blocks.

$$\begin{matrix}Formula ( 33 ) & \\ {Lbr}_{ave} = \frac{Lbr 1 + Lbr 2 + … + Lbrq}{q} & ( 33 ) \\ Formula ( 34 ) & \\ {Lbg}_{ave} = \frac{Lbg 1 + Lbg 2 + … + Lbgq}{q} & ( 34 ) \\ Formula ( 35 ) & \\ {Lbb}_{ave} = \frac{Lbb 1 + Lbb 2 + … + Lbbq}{q} & ( 35 ) \\ Formula ( 36 ) & \\ {Lbw}_{ave} = \frac{Lbw 1 + Lbw 2 + … + Lbwq}{q} & ( 36 )\end{matrix}$$

In step 40, near infrared light level estimating portion 32 conducts a weighted average of the average values Rbrₐᵥₑ, Rbgₐᵥₑ, Rbbₐᵥₑ, and Rbwₐᵥₑ in the road surface blocks 95 and the average values Lbrₐᵥₑ, Lbgₐᵥₑ, Lbbₐᵥₑ, and Lbwₐᵥₑ in dividing line blocks 96, using Formulas (37), (38), (39), and (40) to calculate the Rₐᵥₑ, Gₐᵥₑ, Bₐᵥₑ, and Wₐᵥₑ used in Formula (1).

Formula (37):

Rₐᵥₑ=rr×Rbrₐᵥₑ+lr×Lbrₐᵥₑ(rr+lr=1) (37)

Where rr and lr are weighted coefficients for the road surface block and the dividing line block, respectively.

Formula (38):

Gₐᵥₑ=rg×Rbgₐᵥₑ+lg×Lbgₐᵥₑ(rg+lg=1) (38)

Where rg and lg are weighted coefficients for the road surface block and the dividing line block, respectively.

Formula (39):

Bₐᵥₑ=rb×Rbbₐᵥₑ+lb×Lbbₐᵥₑ(rb+lb=1) (39)

Where rb and lb are weighted coefficients for the road surface block and the dividing line block, respectively.

Formula (40):

Wₐᵥₑ=rw×Rbwₐᵥₑ+lw×Lbwₐᵥₑ(rw+lw=1) (40)

Where rw and lw are weighted coefficients for the road surface block and the dividing line block, respectively.

Next, near infrared light level estimating portion 32 proceeds to step 41 and terminates the process.

In Step 37, if there is only one of either a valid road surface block 95 or a valid dividing line block 96, it branches to step 50, and near infrared light level estimating portion 32 determines whether there is a valid block. If there is a valid road surface block 95 (if there is only a valid road surface block), it proceeds to step 51, and if there is no valid road surface block (if there is only a valid dividing line block), it branches to step 60.

Steps 51 and 52 are the calculation process for the average gradient values Rₐᵥₑ, Gₐᵥₑ, Bₐᵥₑ, and Wₐᵥₑ when there is only a valid road surface block.

In step 51, near infrared light level estimating portion 32 calculates Rbrₐᵥₑ, Rbgₐᵥₑ, Rbbₐᵥₑ, and Rbwₐᵥₑ, which are the average values of Rbr, Rbg, Rbb, and Rbw, respectively, of all of the valid road surface blocks 95, using Formulas (29), (30), (31), and (32).

In step 52, near infrared light level estimating portion 32 proceeds to step 41 with Rbrₐᵥₑ as Rₐᵥₑ, Rbgₐᵥₑ as Gₐᵥₑ, Rbbₐᵥₑ as Bₐᵥₑ, and Rbwₐᵥₑ as Wₐᵥₑ and terminates the process.

Steps 60 and 61 are the calculation process of the average gradient values Rₐᵥₑ, Gₐᵥₑ, Bₐᵥₑ, and Wₐᵥₑ when there is only a valid dividing line block.

In step 60, near infrared light level estimating portion 32 calculates Lbrₐᵥₑ, Lbgₐᵥₑ, Lbbₐᵥₑ, and Lbwₐᵥₑ, which are average values of Lbr, Lbg, Lbb, and Lbw, respectively, of all of the valid dividing line blocks, using Formulas (33), (34), (35), and (36).

In step 61, near infrared light level estimating portion 32 proceeds to step 41 with Lbrₐᵥₑ as Rₐᵥₑ, Lbgₐᵥₑ as Gₐᵥₑ, Lbbₐᵥₑ as Bₐᵥₑ, and Lbwₐᵥₑ as Wₐᵥₑ and terminates the process.

By the processes of steps 40, 52, or 61, near infrared light level estimating portion 32 calculates Rₐᵥₑ, Gₐᵥₑ, Bₐᵥₑ, and Wₐᵥₑ for any of a valid road surface block and valid dividing line block (step 40), a valid road surface block (step 52), and a valid dividing line block (step 61). Further, near infrared light level estimating portion 32 substitutes the calculated Rₐᵥₑ, Gₐᵥₑ, Bₐᵥₑ, and Wₐᵥₑ in Formula (1) to calculate index value C_{index} that indicates the light receiving level of near infrared light.

Note that, in this embodiment, near infrared light level estimating portion 32 determined the correction matrix by index value C_{index} calculated by Formula (1). However, the present disclosure also contemplates color image 43 may be generated by an alternative method that estimates the level of near infrared light according to a degree of difference between the gradient values of the color pixels (R, G, and B pixels) and the gradient value of the W pixels in the original image 41 and then corrects the gradient values of each pixel of pre-correction color image 42 according to the estimated level of the estimated near infrared light.

Further, in this embodiment, color image generating portion 33 generated color image 43 after generating pre-correction color image 42, but color gradient values (R, G, and B gradient values) directly allocated to each pixel of color image 43 from the gradient values of each pixel of the original image 41 may also be calculated without generating pre-correction color image 42, is also contemplated by the present disclosure.

The foregoing description of embodiments and examples has been presented for purposes of illustration and description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent devices by those of ordinary skill in the art. Rather it is hereby intended the scope be defined by the claims appended hereto. Additionally, the features of various implementing embodiments may be combined to form further embodiments of the invention.

What is claimed is:

1. An environment monitoring system comprising:
at least one camera mounted on a vehicle, the at least one camera capturing images with an imaging element including a plurality of color light receiving pixels receiving light through a color filter and a plurality of clear light receiving pixels that receive light without passing through the color filter in an original image data;
an image controller in communication with the at least one camera and receiving the original image data, the image controller including:
an original image acquiring portion acquiring the original image data, in which a plurality of color pixels where a gradient value is allocated individually according to the level of light received by each color light receiving pixel and a plurality of clear pixels where a gradient value is allocated individually according to the level of light received by each clear light receiving pixel are arranged;
a near infrared light level estimating portion estimating a level of near infrared light received by the imaging element based on a difference between the gradient value of the color pixels and the gradient value of the clear pixels for the original image data;
a color image generating portion generates a color image, for each of the pixels of the original image data, by allocating to clear pixels a corrected color gradient value, in which a color gradient value allocated according to a gradient value of a color pixel arranged peripherally is corrected based on the level of near infrared light estimated by the near infrared light level estimating portion, as a gradient value for a pixel in a corresponding placement position in a color image, and allocating to color pixels a corrected color gradient value, in which a color gradient value allocated according to a gradient value arranged peripherally, or the gradient value itself, is corrected based on the level of near infrared light estimated by the near infrared light level estimating portion, as a gradient value for a pixel in a corresponding placement position in a color image; and
a target object detecting portion analyzes the color image to detect a target object that exists in a periphery of the vehicle.

2. The environment monitoring system according to claim 1, wherein the color filter is a color filter of three colors with a plurality of color light receiving pixels, the plurality of color light receiving pixels each receive light through the color filter of any one of the three colors; and
the color image generating portion generates a color image, for each of clear pixels of the original image, by allocating color gradient values for each of the three primary colors based on the gradient values of the color pixels arranged peripherally, and, for each of color pixels of the original image, allocating color gradient values for each of the three primary colors based on the gradient values of the other color pixels arranged peripherally, or on the gradient value itself, calculating corrected color gradient values for each of the three primary colors by correcting the color gradients of each of the three primary colors allocated to the clear pixels and the color pixels of the original image using an arithmetic process on a correction factor determined according to the level of near infrared light estimated by the near infrared light level estimating portion and an element based on at least one of the color gradient values of the three primary colors, and allocating the corrected color gradient values of the three primary colors to pixels that correspond to the color image.

3. The environment monitoring system according to claim 2, wherein the color filter of three colors includes three colors of red, green, and blue.

4. The environment monitoring system according to claim 2, wherein the color filter of three colors includes three colors of cyan, magenta, and yellow.

5. The environment monitoring system according to claim 1, wherein the near infrared light level estimating portion calculates average gradient values of clear and color pixels in near infrared light level estimating regions of the original image data with a high likelihood of a road or lane dividing lane and estimates a level of near infrared light received by the imaging element based on a degree of difference of the averages between a gradient value of the clear pixels and a gradient value of the color pixels in the near infrared light level estimating region.

6. The environment monitoring system according to claim 3, wherein the near infrared light level estimating portion sets a plurality of the near infrared light level estimating regions and estimates, from among the plurality of near infrared light level estimating regions, a level of near infrared light received by the imaging element as a target for the near infrared light level estimating region where a ratio of clear pixels having a gradient value of not less than a first predetermined value is not more than a first threshold value and a ratio of color pixels having a gradient value of not less than a second predetermined value is not more than a second threshold value.

7. The environment monitoring system according to claim 3, wherein the near infrared light level estimating portion sets a plurality of the near infrared light level estimating regions and estimates, from among the plurality of near infrared light level estimating regions, a level of near infrared light received by the imaging element as a target for the near infrared light level estimating region where a ratio of clear pixels having a gradient value of not more than a third predetermined value is not more than a third threshold value and a ratio of color pixels having a gradient value of not more than a fourth predetermined value is not more than a fourth threshold value.

8. A vehicle comprising:
at least one camera mounted on the vehicle, the camera capturing images with an imaging element including a plurality of color light receiving pixels receiving light through a color filter and a plurality of clear light receiving pixels that receive light without passing through the color filter in an original image data;
an image controller in communication with the at least one camera receiving the original image data from the at least one camera, the image controller including:
an original image acquiring portion acquiring the original image data from the at least one camera, in which a plurality of color pixels where a gradient value is allocated individually according to the level of light received by each color light receiving pixel and a plurality of clear pixels where a gradient value is allocated individually according to the level of light received by each clear light receiving pixel are arranged;
a near infrared light level estimating portion estimating a level of near infrared light received by the imaging element based on a difference between the gradient value of the color pixels and the gradient value of the clear pixels for the original image data;
a color image generating portion generates a color image, for each of the pixels of the original image data, by allocating to clear pixels a corrected color gradient value, in which a color gradient value allocated according to a gradient value of a color pixel arranged peripherally is corrected based on the level of near infrared light estimated by the near infrared light level estimating portion, as a gradient value for a pixel in a corresponding placement position in a color image, and allocating to color pixels a corrected color gradient value, in which a color gradient value allocated according to a gradient value arranged peripherally, or the gradient value itself, is corrected based on the level of near infrared light estimated by the near infrared light level estimating portion, as a gradient value for a pixel in a corresponding placement position in a color image; and
a target object detecting portion analyzes the color image to detect a target object that exists in a periphery of the vehicle;
a vehicle controller including a steering control unit, a braking control unit, and a display control unit; and
a controller area network enabling communications between the vehicle controller, the image controller, the steering control unit, the braking control unit, and the display control unit; and;
wherein the vehicle controller receives target object detection information in the periphery of the vehicle and sends command signals to either one of the steering control unit, the braking control unit, and the display control unit based on the target object detection information and a set of predetermined vehicle and environmental conditions.

9. The vehicle of claim 8, wherein the target object detection information detects road surface and lane dividing lines; and
the target object detection information detects the vehicle moving outside of the lane dividing lines; and
the vehicle controller activates the display control unit to display a warning to alert the driver of the vehicle moving outside of the lane dividing lines.

10. The vehicle of claim 8, wherein the target object detection information detects road surface and lane dividing lines; and
the target object detection information detects the vehicle moving outside of the lane dividing lines; and
the vehicle controller activates the steering control unit to control a steering wheel to maintain vehicle between the lane dividing lines under predetermined conditions of vehicle outside of the lane dividing lines.

11. The vehicle of claim 8, wherein the target object detection information detects a red light or stop sign; and
the vehicle controller activates the display control unit to display a warning to alert the driver of stop sign or red light.

12. The vehicle of claim 8, wherein the target object detection information detects another vehicle in the periphery of the vehicle; and
the vehicle controller activates the display control unit to display a warning to alert the driver of another vehicle in the periphery of the vehicle.

13. The vehicle of claim 8, wherein the target object detection information detects the vehicle approaching another vehicle; and
the vehicle controller activates the brake control unit to initiate the braking device if braking is not initiated by the driver, within a specified time or detected distance of the another vehicle.

14. The method of detecting objects, comprising the steps of:
acquiring an original image of a periphery of a vehicle with a vehicle mounted camera;
calculating an average gradient value of all color and clear pixels of the original image; and
calculating a correction index, the correction index indicating an estimated level of a near infrared light received by an imaging element of the camera with a coefficient indicating a sensitivity difference between the white/clear light receiving pixels and the color light receiving pixels in a visible light region.

15. The method of claim 14, further comprising the steps of:
determining a correction matrix for white balance adjustment according to the correction index;
generating a pre-correction color image by demosaicing the gradient values of each color pixel of the original image;
generating a color image using the correction matrix to correct the gradient values of each color pixel of the pre-correction image; and
analyzing the color image to detect target objects in the periphery of the vehicle.

16. The method of claim 15, further comprising:
detecting the target objects of lane dividing lines from color attributes of the color image;
detecting a position of the vehicle is outside of the lane dividing lines; sending a display control signal from the vehicle controller to display an alert to driver of vehicle is outside of the lane dividing lines; and
sending a steering control signal from the vehicle controller if the vehicle outside of the lane dividing lines and a set of predetermined vehicle and environmental conditions are met to maintain the vehicle within the lane dividing lines.

17. The method of claim 15, further comprising:
detecting a vehicle ahead from color attributes of the color image;
determining a time to collision based on the vehicle position with the vehicle ahead;
sending a braking control signal by the vehicle controller to initiate brakes to avoid contact with the vehicle ahead if a braking operation does is not initiated by the driver within a specified time or detected distance; and
sending a steering control signal by the vehicle controller to steer the vehicle away to avoid contact with the vehicle ahead if a steering operation is not initiated by the driver within a specified time or detected distance;

18. The method of claim 15, further comprising:
detecting a red light or a traffic signal in front from color attributes of the color image;
displaying a warning signal by the vehicle controller to alert driver if a braking operation is not initiated by the driver within a specified time or detected distance of the red light or a traffic signal; and
sending a braking control signal by the vehicle controller to initiate brakes to stop vehicle if a braking operation is not initiated by the driver within a specified time or detected distance of the red light or traffic signal.

19. The method of claim 15 further comprising the steps of:
setting a plurality of road surface blocks in regions of the image where road surfaces likely exist;
calculating a saturation ratio and a totally black ratio of the all colors and clear/white pixels for each road surface block;
determining whether there is a valid road surface block in which the saturation ratio of the white/clear pixels is not more than a first threshold value and none of the saturation ratios of the color pixels are more than a second threshold value, and in which the totally black ratio of the white/clear pixels is not more than a third threshold value and none of the totally black ratios of the color pixels are more than a fourth threshold value;
calculating an average gradient value of all color and clear/white pixels for each of the valid road surface blocks.

20. The method of claim 15 further comprising the steps of:
setting a plurality of dividing line blocks in regions of the image where lane dividing lines likely exist;
calculating a saturation ratio and a totally black ratio of all colors and clear/white pixels for each dividing line block;
determining whether there is a valid dividing line block in which the saturation ratio of the white/clear pixels is not more than a first threshold value and none of the saturation ratios of the color pixels are more than a second threshold value, and in which the totally black ratio of the white/clear pixels is not more than a third threshold value and none of the totally black ratios of the color pixels are more than a fourth threshold value; and
calculating an average gradient value of all color and clear/white pixels for each of the valid dividing line blocks.
